(19) United States
(12) Patent Application Publication
(10) Pub. No.: US 2013/0199388 A1
(43) Pub. Date: Aug. 8, 2013

(54) MARK, METHOD AND SYSTEM FOR COLOR QUALITY PARAMETERS MEASUREMENT

(71) Applicant: Modesto Luengo Bada, Zaragoza (ES)

(72) Inventor: Modesto Luengo Bada, Zaragoza (ES)

(73) Assignee: Fernando de Yarza López-Madrazo, Zaragoza (ES)

(21) Appl. No.: 13/636,625

(22) PCT Filed: Mar. 24, 2011
(86) PCT No.: PCT/EP11/54564

§ 371 Date: Apr. 24, 2013

(30) Foreign Application Priority Data
Mar. 25, 2010 (EP) 10382067.6

(51) Int. Cl. B41F 33/00

(52) U.S. Cl. CPC B41F 33/0081
USPC 101/211; 101/481

(57) ABSTRACT

A mark, a method and a system for colour quality parameters measurement of a printing press. The mark comprises a plurality of spots, wherein each spot comprises encoded dot level information, the distribution of spots defines a signature pattern for each process colour, a plurality of said spots is associated to each ink key of the printing press along an area of interest and the mark is invisible to the naked eye. The colour quality parameters measurement system comprises image capturing means synchronizable with the printing press and capable of accessing the entire width of an area of interest of the printing press, processing means, user control interface for communication between the processing means and the press user and a mark according to the invention. The method for colour quality parameters measurement comprises the steps of printing a mark according to the invention on an area of interest of a printing job, capturing an image of the printed mark, identifying process colour in the mark and determining at least one colour quality parameter.

### TECHNICAL FIELD

The present invention relates to a mark, a method and a system for colour quality parameters measurement in a moving web of multicolour print for use in multicolour, industrial, non-digital printing processes.

The mark, method and system of the invention enable inline monitoring of colour quality via colour control and colour-to-colour register control and allows all the necessary quality variables, namely ink film thickness, dot gain, lateral and circumferential colour-to-colour register and fan out to be measured along every ink key zone throughout the entire print run thus providing an optimum means and method for making the necessary adjustments to the printing press.

### DESCRIPTION OF RELATED ART

Although there are several industrial printing technologies, including flexo (where the image to be printed is raised from a printing plate) and gravure (where the image to be printed is engraved or sunk into the printing plate), all have the same inherent industrial printing issues of dot level variations that significantly affect colour. The most widely used printing process however, is the litho offset process, where a solution based on water and ink is applied to a printing plate with the image to be printed, then transferred or offset to a blanket cylinder and finally printed on the web paper.

In the case of the CMYK (Cyan, Magenta, Yellow, Black) colour model, four process colours must be applied via four different printing units. Although it varies, inks are typically applied in the order of the CMYK abbreviation.

Ink film thickness can be measured by measuring the amount of light reflected from a surface ink. This measurement gives an optical density value known in the printing industry simply as ink density. Ink density is a function of the percentage of light reflected.

In printing, in order to achieve the full colour gamut possible with the process colours a technique known as halftoning is adopted, according to which tiny dots of each primary colour are printed close to each other so that the human eye perceives a single colour. With halftoning, it is changes at the dot level, including changes in dot alignment and dot size that significantly affect the colour perceived by the human eye.

Variations between the expected size of an electronic dot in the document original and the same dot as it appears after the printing process, is known as dot gain. Dot gain is a printing process-inherent problem and occurs due to many different process-inherent causes, all however, significantly impacting the colour perceived by the human eye.

Fan out is another common industrial print defect that occurs due to differences in tension between the web as it enters the first set of colour printing rollers and as it exits the final set of colour printing rollers. If measured at the sides, fan out can be mistakenly taken to be a lateral colour-to-colour register defect, however cannot be corrected via the lateral colour-to-colour register motors.

Among the most important source of defects inherent to industrial printing processes are colour-to-colour register and ink film thickness, which are briefly discussed below.

### Colour-to-Colour Register: Lateral and Circumferential Alignment of Printing Cylinders

Dot alignment between the process colour dots that can even lead to dot overlap significantly impacts the colour perceived by the human eye. Dot alignment is obtained as a result of the alignment of the cylinders of the printing units of each process colour which must be perfect in both lateral (left-right) and circumferential (forward-backward) directions. Otherwise the human eye would perceive a change in the colour, a loss of sharpness and a blurred image.

### Ink Level:

Industrial printing presses have systems dedicated to supply the correct amount of ink to the printing cylinder also known as the plate cylinder. The most common method of supplying and controlling the ink of a particular colour to be applied in industrial offset printing presses is via the use of motorized ink keys, which consist of individual motorized mechanical gates that can be controlled in order to regulate the amount of ink that can pass to the plate cylinder at the particular location where the ink key is found. The ink key motorized gate can be either raised or lowered in order to allow more or less flow of ink to the printing press plate cylinder at the ink key location.

For each of the previously described inherent problems found in industrial printing processes, the industry has developed techniques and technologies in order to move towards the goal of efficiently and accurately obtaining the desired colour of the final printed product. The most widely used techniques, which represent the current state of the art, are operator colour matching, use of handheld devices, automatic closed loop colour-to-colour register and automatic closed loop density control, which are shortly discussed below.

### Operator Colour Matching:

By far the most common practice today is still manual colour matching by the press operator. During the start up of the print job, normally carried out at a reduced press operating speed, the press operator manually corrects the inking until a good visual match is achieved with the colour original. The typical mechanism is as follows: A printed sample is obtained from the printing press and the CMYK printed image is compared visually with a PDF electronic colour original typically on display on an RGB monitor.

Frequently, density control patches and register crosshairs are placed on the printed product in order to provide a solid density target for the operator to inspect with the aim being to achieve a more reliable colour comparison compared to a visual check of the print itself. Once visually inspected, the press operator adjusts the ink key gates and dampening solution levels that change the ink film thickness and hence individual colour density.

In summary density control patches and print itself are manually inspected for colour control. However, it is changes at the dot level which are inherent to the industrial printing process that have a far greater impact on colour than changes in solid ink densities. In fact, the vast majority of colour defects are caused by these process inherent changes that occur during the print run at the dot level and are therefore not related to colour. At the dot level, changes in dot size, dot shape, dot alignment and dot overlap as well as many other factors significantly affect the colour of the final printed product and are overlooked during manual operator colour matching.

### Handheld Devices: Densitometers, Colorimeters and Photospectrometers

In the graphic arts industry, several handheld devices exist that are used to measure colour.

Densitometers use reflection densitometry to measure ink film thickness and provide an optical density value. Colorimeters and photospectrometers are devices that objectively measure colour based on a small sample area.

The use of handheld devices, especially densitometers, is widespread, however, presents in practice a number of problems in the efficient measurement and control in order to obtain the desired colour. Among the most important issues are the facts that those devices have to be used offline, that depending on the sample printed not always all ink keys can be measured in an easy way, and that measures obtained do not provide an accurate and simple means for press operators to make the necessary adjustments on the printing press. Also important is the fact that measured quantities using colorimetry and photospectrometry techniques, although adequate for colour quality control of a printed product, do not provide an accurate means for press operators to make the necessary adjustments on the printing press. Empirical mappings have to be made in order to be able to accurately make the necessary printing press adjustments, thus introducing error to the measurement and control process.

Another handheld device that exists is the dot meter. Dot meters are seldom used in the graphic arts industry. However, the offline measurement of dot gain is widely carried out using reflection densitometers. Dot gain is measured using reflection densitometry by the offline analysis of tones of various percentages of colour—typically 25%, 50% and 75% (or halftones), 100% (solids)—in order to determine the individual dot gain of a certain colour.

From a control theory perspective, the use of handheld devices, such as densitometers, colorimeters, photospectrometers and dot meters or reflection densitometers for measuring dot gain can be described as open loop control mechanisms due to the necessary intervention of the press operator thus making it impossible to have a fully automatic control loop.

### Automatic Closed Loop Colour-to-Colour Register

An automatic closed loop colour-to-colour register is a system that intends to mechanize the functions of the press operator through the use of computer equipment and systems. In a very simplified way, such a computer system includes the use of cameras for the capture of images containing small colour marks associated to each colour printing unit, computers for the analysis of images and for performing different calculations and control systems for managing the printing engines and for performing the necessary corrections.

These systems measure and perform inline correction of lateral and circumferential register control based on the measurements taken at a particular fixed point where the cameras are located and the register marks pass. These systems are not adequate for colour control and only cover inline colour-to-colour register measurement.

### Automatic Closed Loop Density Control

In commercial printing automatic closed loop density control systems have existed for a number of years. These systems comprise image capture devices, based on colour cameras or spectrophotometers, and processing means that can analyze and control automatically the colour on a moving web of a printing press.

The inline image capture devices in these systems mimic colorimeters and photospectrometers and rely on the presence of large measurement bars that run across every page of a printed product. Consequently, although adequate for commercial printing processes due to common presence of a guillotine that removes the measurement bar from the printed product, these systems are not suitable for other industrial printing processes such as newspaper printing.

### Markless Automatic Closed Loop Density Control

Recently, in order to break the reliance on measurement bars that many editors—particularly newspaper editors—refuse to place on their products, automatic closed loop density control products that require no marks have entered the market. The markless systems compare an electronic image, such as PDF or TIFF, with the final product. These systems have several difficulties based on the basic approach of trying to operate without any type of measurement bar.

At present, the state of the art presents no single solution to be able to accurately measure the information required for accurate colour control for industrial printing processes. At every ink key location, the accurate measurement of colour with the problems previously described related to colour measurement, the measurement of ink film thickness and the measurement of dot gain as well as measurement of the lateral and circumferential colour-to-colour register has to be carried out via a variety of means and methods.

By way of example, EP0850763B1 discloses a method for monitoring the quality of a moving web of multicolour print during a printing process, comprising monitoring the mutual location of the various colours on the basis of marks arranged on the web of print and further monitoring the location in longitudinal direction and transversal direction of the web of print in relation to at least one printing press. Said marks are arranged on the print in pairs (each pair in one of the colours of the print) according to a predetermined pattern, with a fixed mutual distance in relation to a reference mark.

Although the method of EP0850763B1 provides measurement of colour-to-colour register, it does not allow measurement of ink film thickness nor dot gain and it cannot detect fan-out.

It is an object of the invention to solve the abovementioned problems of the prior art, providing a single mark, system and method which allow accurately inline measuring colour at every ink key location for closed loop control.

### SUMMARY OF THE INVENTION

The present invention provides a mark for colour quality parameters measurement in a printing press according to claim 1, a system according to claim 7, a method according to claim 8 for colour quality parameters measurement in a printing press and an automatic closed loop colour control system for a printing press according to claim 16. Dependent claims 2-6 and 9-15 define preferred embodiments of the present invention.

The mark, system and method of the invention raise the state-of-the-art to a new level and enable both colour control and colour-to-colour register control to be offered within the same system and method without visible marks.

The mark according to a first aspect of the invention comprises a plurality of spots with a distribution that defines a signature pattern for each process colour. In other words, each process colour has a defined configuration of spots that represents its unique signature for that colour. With the mark of the invention, colour detection is done via a unique signature pattern that is incorporated into the mark for each of the process colours required in the printing process. This means that colour does not have to be measured, as it can be identified via comparison with the pattern that the system holds. It is thus provided a means for the process colours to be identified, advantageously avoiding the need to measure colour. Preferably, the stored pattern that the system holds is a series of values held in a database.

A spot as disclosed herein is a matrix of dots, preferably not greater than 0.32 mm×0.32 mm.

An invisible mark as disclosed herein should be construed as a mark invisible to the naked eye and hence invisible to the average reader or consumer of the printed product. The invisibility of the mark of the invention is due to the size of the spots comprised therein and to their distribution, i.e. for a given spot size, the spots are sufficiently spaced from each other to result invisible to the naked eye in the normal conditions of use of the printed product. For example, a mark could be considered to be invisible if it is not visible at a distance of 30 cm in ambient lighting. For this reason, the mark of the invention can be used by even the strictest newspaper editors not willing to impact the aesthetic characteristics of their products.

Advantageously, the invisible mark incorporates information encoded at the dot level and along every individual ink key within the area of interest, thus enabling all the information required to control and to obtain the desired printed colour to be measured in line at every ink key. The information encoded at the dot level shall be construed herein as different CTP dot level configurations defined so that for an individual ink key zone both, solid tones as well as a range of tones can be analyzed so that, if required, dot size or dot gain can be effectively measured and monitored throughout the press run. In a preferred embodiment of the invention different CTP dot level configurations are defined for each to allow for different tones in different slots, such as solid densities and partial densities slots to be defined for each process colour, preferably densities of substantially 100%, 75%, 50%, and 25%. Other values can be used for the densities of the spots. FIG. 3 shows spots comprising 4×2 dots, respectively with densities of 0% (no printed dots), 25% (2 printed dots), 50% (4 printed dots), 75% (6 printed dots) and 100% (8 printed dots).

The mark according to a first aspect of the present invention is placed on the printing plate of each process colour during the pre-printing process for being printed with the print job and runs across an area of interest of the print job, covering every ink key in the area of interest, i.e. there is at least a spot associated to every ink key in the area of interest. In a preferred embodiment the invisible mark runs substantially across the entire width of the printing job, thus comprising information about every ink key along the width of the printing press.

The width of the invisible mark corresponds to the width of the area which requires to be controlled, usually the entire width of the paper being printed, and is valid for single, double and the newly available triple width printing presses now available on the market. The height of the invisible mark is configurable and can be set in a range of values, depending on the printing press in question. Factors such as the available space between print and the non-transfer areas of the print cylinders can be taken into account in order to fix the final position and height of the invisible mark.

In a preferred embodiment of the mark according to the first aspect of the invention, the distribution of spots corresponds to a plurality of slots selected from a grid structure, which is formed by horizontal rows and vertical columns. Thus, a slot as defined herein can be construed as a particular embodiment of a spot, according to its distribution. Each of the selected slots forming part of the mark is associated to a particular ink key and process colour.

In a second aspect, the invention provides an colour quality parameters measurement system for a printing press, comprising:
image capturing means, synchronizable with the printing press and capable of accessing the entire width of an area of interest of the printing press,
processing means,
user control interface for communication between the processing means and the press user, and
a mark according to the first aspect of the invention.

The image capturing means capture a digitized image of the printed web and ensure that the image contains the invisible mark. They can be implemented as a system of motorized cameras. Since the mark of the invention avoids the need for colour to be measured, a black and white camera for capturing a grey-scale image of the printed mark can be advantageously used as the image capturing means.

In a third aspect, the invention provides a method for colour quality parameters measurement of a printing press comprising the steps of:
printing a mark according to the first aspect of the invention on an area of interest of a printing job,
capturing an image of the printed mark,
identifying each of the process colours in the mark, and
determining at least one colour quality parameter.

In the method of the invention the step of determining a colour quality parameter shall be construed as measuring and/or monitoring through the press run said colour quality parameter.

The abovementioned colour quality parameters comprise lateral and circumferential colour-to-colour register, dot gain, ink film thickness and occurrence of fan-out.

Advantageously, the mark, system and method of the invention allow for the first time all the necessary quality variables, namely ink film thickness, dot level changes and lateral and circumferential colour-to-colour register to be measured along every ink key zone throughout the entire print run. In a preferred embodiment, the method and system for colour quality parameters measurements are used to make automatic adjustment to the printing press.

As previously described, lateral and circumferential colour-to-colour register measurement is significant in obtaining the desired colour of the final printed product. Comparison at a given position of the printed invisible mark that incorporates the unique signature of each process colour with the pattern that the system holds allows for lateral and circumferential colour register to be measured by the system.

As abovementioned, the pattern held by the system is preferably a series of values stored in a database. In this case the system after analysing a digitised image and calculating many different parameters then makes a comparison with the stored values.

Advantageously, it is thus avoided comparison of an entire image or part of an image with an electronic PDF or similar format of the original image to be printed, trying to find like areas suitable for analysis, often across ink key zones, and without dot level information.

As the invisible mark comprises information encoded at the dot level, the present invention therefore provides a means for dot alignment and dot overlap to be measured.

Furthermore, the present invention allows for other printing defects such as fan-out to be accurately detected and measured. As the invisible mark can be situated along the entire width of the web of paper, it enables the system and method of the invention to accurately determine whether a print defect is due to a lateral register defect or to a fan-out defect. In order to detect and measure the extent of fan-out, the on-going change in lateral register is calculated for each process colour to be printed with respect to a reference colour, in a section of the mark selected for a particular press and a particular print job with respect to a reference section where no fan-out is likely to occur.

As previously stated, accurate density measurement of the process colours allows for accurate control of ink key levels via the means previously described. Since the process colour is known, the solid and partial ink densities can be easily measured and directly applied without the need for empirical mappings that introduce errors to the measurement made.

The vast majority of colour defects are caused by process inherent changes that occur during the print run at the dot level and are therefore not related to colour, the measurement of colour, or to solid ink densities. The present invention thus provides an effective method for measuring and monitoring these process inherent changes at the very level in which they occur and impact the quality of the colour obtained. The present invention enables dot size or dot gain and dot shape to be all measured and monitored throughout the press run.

The present invention allows for different CTP dot level configurations to be defined so that for an individual ink key zone a range of tones can be analyzed so that dot size or dot gain, and dot shape can be effectively measured and monitored throughout the press run. Different CTP dot level configurations are defined for each to allow for different tones in different slots, such as 25%, 50%, 75% and 100% slots to be defined for each process colour.

As previously explained, the invisible mark of the invention contains the unique signature for each process colour. In this way, dot alignment and dot overlap can be measured and monitored throughout the press run. In this way, the vast majority of colour defects that are caused by these process inherent changes that occur during the print run at the dot level and have no relation to colour or the measurement of colour are successfully measured and monitored by the system and method of the invention.

During digitalization by the image capturing means, artefacts, also often called “noise” appear mainly due to paper anomalies as well as for other reasons. These artefacts appear as dark areas on the digitized image and in certain cases can result in a captured image being rendered invalid for analysis. Due to the size and structure of the invisible mark described earlier, in any given image captured by the system, there are multiple analysis opportunities for each ink key, resulting in the invisible mark being far more resilient to noise and offering a valid image for analysis during a significantly higher percentage of images captured.

In a fourth aspect, the invention provides an automatic closed loop colour control system for a printing press, comprising:
a colour quality parameters measurement system according to a second aspect of the invention, and
a printing press interface device, capable of receiving from the processing means of the colour quality parameters measurement system the commands to be executed and interfaced with the printing press.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 shows a print web comprising an invisible mark according to a preferred embodiment of the invention.

FIG. 2 shows a schematic representation of a preferred embodiment of the invisible mark of the invention.

FIG. 3 shows individual slot configuration examples of CTP level.

FIG. 4 shows an example of a section of the invisible mark.

FIG. 5 shows a printing press comprising a system according to the invention.

Throughout the figures like reference numerals refer to like elements.

### DETAILED DESCRIPTION OF A PREFERRED EMBODIMENT

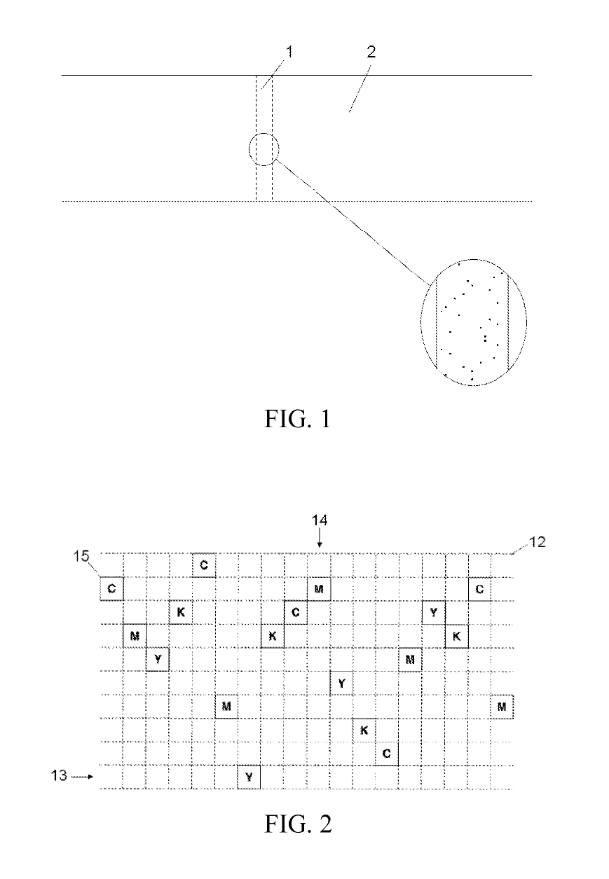

FIG. 1 shows a web (2) comprising a mark (1) according to an embodiment of the invention and an enlarged view of a portion of the mark. The printed mark, invisible to the naked eye, appears as a cloud of spots in the enlarged view. In this embodiment the mark runs substantially along the entire width of the web (2), thus comprising information about every ink key of the printing press. However, when only a section of the web (2) requires being quality-controlled, it may be advantageous to print the mark only along said area of interest, instead of along the entire width of the web (2).

FIG. 2 shows a schematic representation of a preferred embodiment of the mark (1) of the invention. In this embodiment the distribution of spots of the mark (1) follows a grid structure (12) formed by horizontal rows (13) and vertical columns (14). The intersections of the rows (13) and the columns (14) create individual rectangular zones with a defined height and width called slots (15), as previously mentioned. From all the available slots comprised in the grid structure, a number is selected to form part of the mark. Gridlines of the grid structure (12), although included in FIG. 2 for a clear observation of the grid structure (12), do not form part of the mark (1) and are not printed. Only the information of the selected slots (15) is printed. Each selected slot (15) corresponds to a particular ink key and process colour. In FIG. 2 the process colours cyan, magenta, yellow and black have been represented, respectively, by labels C, M, Y and K.

White slots (slots with 0% density) can also be included in the invisible mark, i.e. not all consecutive columns are necessarily printed by a process colour, which increases the invisibility of the mark to the naked eye.

According to the invention, each process colour occupies a defined configuration of slots (15) where the position of the occupied slots represents a unique signature for that colour. This means that colour does not have to be measured, since it can be identified via comparison with the control pattern that the system holds. The stored pattern that the system employs is preferably a series of values held in a database or similar.

In a preferred embodiment of the mark two rules are followed to select the slots: 1) The same process colour is not placed in two consecutive vertical columns, and 2) Two consecutive slots are not placed in the same horizontal row. This embodiment increases invisibility of the mark to the naked eye.

In the embodiment of FIG. 2, in a vertical column (14) only one slot (15) is used for one process colour. In the next column (14), a different slot (15) and a different process colour is used. Again, in the next column (14), a different slot (15) and a different process colour is used. This sequence is repeated till the end of the mark. Nevertheless, the mark of the invention can be implemented in alternative ways.

In a preferred embodiment the dimensions of each spot are not greater than 0.32 mm×0.32 mm.

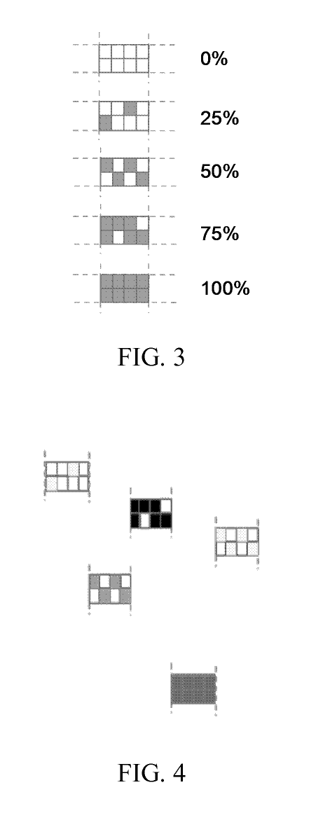

According to the invention, each spot incorporates information encoded at the dot level, which information is printed on the printing job. FIG. 3 shows configuration examples of individual slots (15) comprising pre-programmed information encoded at the dot level, implemented in this embodiment as solid densities (100%) and halftone densities (substantially 75%, 50% and 25%). In this figure five slots are depicted, each having 4×2 dots with different dot densities. Although exemplified for the embodiment of the mark (1) comprising slots (15), the implementation of pre-programmed information encoded at the dot level shown in this figure would be equally applicable to other embodiments of the mark (1).

FIG. 4 shows a configuration example of a section of an invisible mark (1) according to an embodiment of the invention. Namely five slots are depicted, each containing 4×2 dots. This could be, for example, an enlarged view of a section of FIG. 2.

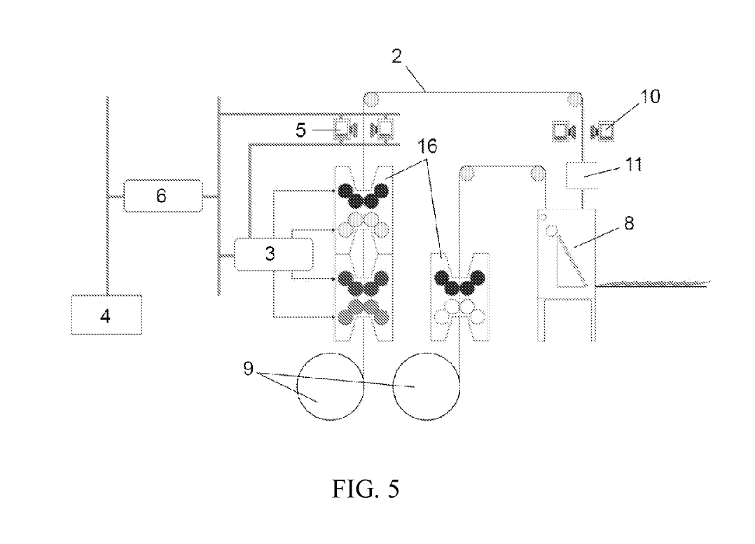

FIG. 5 shows a schematic view of a printing press including paper rolls (9), colour and B/W printing towers (16), a folder (8), a cutting register inspection device (10), a cutting section (11) and an automatic colour control system according to an embodiment of the invention.

The automatic colour control system depicted in FIG. 5 comprises image capturing means (5) for capturing an image of the mark, processing means (6) for processing the data received and for storing configuration parameters, a printing press interface device, for example a programmable logic controller (3) with required inputs and outputs and a user control interface (4) for communication between the processing means and the press user.

The image capturing means (5), in this example a motorized system of cameras, such as CCDs, captures a digitized image of the printed web (2) and ensures that the image contains the invisible mark (1) of the invention valid for subsequent analysis. The image capturing means (5) is synchronized with the printing press and has access to the entire width of the printing press thus covering every ink key gate along the whole width if required. In a preferred embodiment of the invention, the image capturing means (5) captures a grey-scale image of the printed mark (1), since colour measurement is no longer needed, as each process colour can be identified thanks to its unique signature pattern.

The processing means (6) carry out the core data processing activities on the data received via specially designed software programs where the systems' intelligence is incorporated. Storage of various configuration parameters also takes place. Some preliminary calculations can also be made before the results of the analyzed image are sent to the processing means (6). The processing means (6) can be partially comprised in the image capturing means (6), if intelligent or smart cameras are used, or can be implemented as external processing means, such as a PC.

The printing press interface device (3), in this example a PLC, receives from the processing means (6) commands to be executed and interfaced with the printing press.

The user control interface (4) interacts with the press users receiving indications from them and communicating with the processing means (6).

A preferred embodiment of the method of the invention after the steps of printing the mark and capturing its image will be now described.

At each ink key location, each process colour is identified via the colour's signature pattern. This is done by comparing the geometric position between all digitised spots against stored data that represents the expected location of the spots for each process colour. Colour-to-colour register regulation is then calculated and executed according to detected deviations from a reference colour.

The percentage of light reflected under a standard illumination condition is then measured for each slot and the optical density and dot gain of the theoretical area around the centre of each dot are calculated according to the dot level configuration used. This is done by measuring via the CCD the amount of light reflected for each dot taking into account the expected value of light reflected under standardised lighting conditions. First the centre of the dot is found, and then a theoretical dot size area around the centre is defined for analysis, finally, the amount of light reflected from the defined area is measured. This measurement is then used to calculate optical density and dot gain via equations. Deviations between the measured values and the expected values for optical density and dot gain are calculated for each slot taking into account each individual expected dot level configuration.

The process is then repeated for the next ink key location of the area of interest.

In order to detect and measure the extent of fan-out at least one zone is defined. For such at least one zone defined one of the process colours is selected as a reference colour and the on-going change in lateral register is calculated for the other process colours with respect to said reference colour. Calculation of the on-going change in lateral register is performed in at least one selected section of the mark with respect to a reference section of the mark, within the zone analyzed. The at least one selected section of the mark is associated to at least one section of the ink keys where fan-out is the only printing defect which is likely to occur within the zone analyzed. Thus, the criteria for selecting the at least one zone, reference sections and the selected sections of the mark are based on the historical behaviour of the fan-out in the specific press and the number of ink keys used in the specific job. The more zones are defined the more accurate the extent of fan-out is measured.

Since the measure is performed at selected sections of the ink keys, the present invention advantageously allows fan-out to be identified and distinguished from other printing defects.

The present invention provides an effective invisible mark, system and method for enabling inline monitoring of colour quality via colour monitoring and colour-to-colour register monitoring and allows all the necessary quality variables, namely ink film thickness, dot gain, lateral and circumferential colour-to-colour register and fan out to be measured along every ink key zone.

1.-16. (canceled)

17. A mark for colour quality parameters measurement of a printing press that includes a plurality of ink keys, the mark comprising a plurality of spots, wherein at least some spots of said plurality of spots are associated to particular ink keys of said plurality of ink keys of the printing press along an area of interest,
characterized in that:
the plurality of spots comprises encoded dot level information;
a distribution of the plurality of spots defines a signature pattern for each process colour of a plurality of process colours;
the mark is invisible to a naked eye of a human observer; and
the encoded dot level information comprises solid densities and/or partial densities for the plurality of process colours.

18. A mark for colour quality parameters measurement according to claim 17, wherein the encoded dot level information comprises solid densities of substantially 100% and partial densities of substantially 75%, substantially 25% and substantially 50%.

19. A mark for colour quality parameters measurement according to claim 17, wherein the mark comprises a height of between 1 mm and 20 mm.

20. A mark for colour quality parameters measurement according to claim 17, wherein the distribution of the plurality of spots corresponds to a plurality of slots selected from a grid structure formed by horizontal rows and vertical columns, and each slot of said plurality of slots is associated to a particular ink key and process colour.

21. A mark for colour quality parameters measurement according to claim 17, wherein each spot of said plurality of spots comprises dimensions of not greater than 0.32 mm×0.32 mm.

22. A colour quality parameters measurement system for a printing press, the colour quality parameters measurement system comprising:
a mark according to claim 17;
an image capturing element synchronizable with the printing press, capable of accessing an entire width of an area of interest of the printing press, and arranged to capture an image of the mark;
a processing element; and
a user control interface arranged to permit communication between the processing means and a user of the printing press.

23. A method for measuring colour quality parameters of a printing press, the method comprising the steps of:
printing a mark according to claim 17 on an area of interest of a printing job;
capturing an image of the printed mark;
identifying information representative of each process colour of the plurality of process colours in the captured image of the printed mark; and
determining at least one colour quality parameter utilizing the identified information.

24. A method for measuring colour quality parameters according to claim 23 wherein said identifying of information comprises comparing the captured image of the printed mark with a stored pattern.

25. A method for measuring colour quality parameters according to claim 23 wherein the captured image of the printed mark is a grey-scale image.

26. A method for measuring colour quality parameters according to claim 23 wherein said determining of at least one colour quality parameter comprises at least one step selected from the group of:
measuring lateral and/or circumferential colour-to-colour register;
identifying occurrence of a fan-out defect;
determining at least a dot level parameter selected from: dot gain, dot alignment and dot overlap; and
measuring an ink film thickness.

27. A method for measuring colour quality parameters according to claim 26 wherein measuring lateral and/or circumferential colour-to-colour register comprises comparing the captured image of the printed mark with a stored pattern.

28. A method for measuring colour quality parameters according to claim 26 wherein identifying occurrence of a fan-out defect comprises detecting in at least one zone deviations between a reference process colour and each of the remaining process colours in the captured image of a printed selected section of the mark with respect to a captured image of a printed reference section of the mark.

29. A method for measuring colour quality parameters according to claim 26 wherein determining dot gain comprises determining solid and partial ink densities for at least one colour.

30. A method for measuring colour quality parameters according to claim 26 wherein measuring an ink film thickness is performed via reflection densitometry.

31. An automatic closed-loop colour control system for a printing press, the system comprising:
a colour quality parameters measurement system according to claim 22, and
a printing press interface device, interfaced with the printing press and arranged to receive from the processing element of the colour quality parameters measurement system commands to be executed by the printing press.
